(19) United States
(12) Patent Application Publication
(10) Pub. No.: US 2021/0304596 A1
(43) Pub. Date: Sep. 30, 2021

(54) TRAFFIC REPORTING AND ANALYSIS

(71) Applicant: Arcadis U.S., Inc., Highlands Ranch, CO (US)

(72) Inventors: Soheil S. Sajjadi, Huntersville, NC (US); Luis D. Alvergue, Austin, TX (US); Thomas J. Montz, JR., Baton Rouge, LA (US)

(21) Appl. No.: 16/991,763

(22) Filed: Aug. 12, 2020

Related U.S. Application Data
(60) Provisional application No. 63/002,932, filed on Mar. 31, 2020.

(51) Int. Cl. G08G 1/01; G06Q 50/08; G06Q 10/06; G06F 16/29

(52) U.S. Cl. CPC G08G 1/0145; G08G 1/0129; G06F 16/29; G06Q 10/0631; G06Q 50/08

(57) ABSTRACT

Systems, methods and software are disclosed for a tool for traffic operations engineers and transportation planners to use to determine, show, approximate, or estimate the effects of construction or other impediments will have on segments of roadways.

### CROSS-REFERENCE TO RELATED APPLICATION

This application claims priority to and the benefit under 35 U.S.C. § 119(e) to U.S. Provisional Patent Application Ser. No. 63/022,932 filed Mar. 31, 2020, which is incorporated by reference in its entirety.

### FIELD OF THE INVENTION

Embodiments of the present invention are generally related to devices for traffic reporting and analysis.

### BACKGROUND

Many people use cars, busses and other forms of transportation on roads to travel and to get to and from work, etc. Traffic studies help engineers, states, etc. evaluate traffic on the roads.

Road construction projects have a significant effect on the operational performance of the roads (say, freeways) leading to an increase in congestion and delay during the construction period. The effect could vary by the type of road project, day-of-the-week, and time-of-the-day.

States, cities, municipalities and others may need to know the effects of construction on traffic flows, speeds, density, delay, etc.

### SUMMARY OF THE INVENTION

Accordingly, one object of the present disclosure is to provide systems, methods, and software for traffic evaluation and analysis. In some preferred embodiments, one method of traffic evaluation and analysis may include receiving inputs from a user, where the inputs may include the road extent, geometric information, facility demand profile, type of road, work zone type, number of lanes closed, barrier type, work zone speed limits, etc. In these embodiments, the user inputs may be sent to a processor that may create output information, which may be calibrated and based at least in part on the user inputs, GIS database information, and information from other databases and other sources. In these embodiments, the output information may include level of service (LOS), demand/capacity ratio, volume/capacity ratio, speed, volume, flowrate, and density in time-space format.

In some preferred embodiments, systems and methods of traffic evaluation and analysis, comprise receiving initial parameters related to a highway construction project, obtaining additional information related to the highway construction project, based at least in part on the initial parameters, creating output information based at least in part on the initial parameters and the additional information, and presenting the output information. In these embodiments, the initial parameters include a geographical start point and end point of the highway construction project, which define a segment. In these embodiments, the geographical start and end point are user selectable from a map interface, and the additional information is contained in a single database.

The Summary is neither intended nor should it be construed as being representative of the full extent and scope of the present disclosure. The present disclosure is set forth in various levels of detail in the Summary, as well as in the attached drawings and the Detailed Description, and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. Further details and other features will become apparent after review of the following Detailed Description and accompanying drawing figures.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

In the drawings:

FIG. 1 illustrates is a method of traffic reporting and analysis, according to an example.

FIG. 2 illustrates a traffic reporting and analysis system environment, according to an example.

FIG. 3 illustrates a user interface showing the user input, according to an example.

FIG. 4 illustrates a user interface showing the output, according to an example.

FIG. 5 shows the structure of a database, according to an embodiment.

FIG. 6 illustrates a traffic reporting and analysis system environment, according to an example.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all of the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

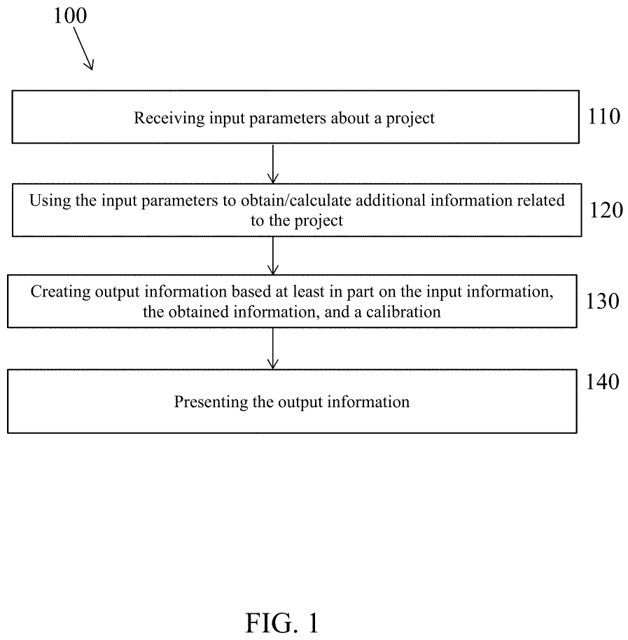

FIGS. 1-6 and the following description depict specific examples of the invention to teach those skilled in the art how to make and use the invention described herein. For the purpose of teaching inventive principles, some conventional aspects have been simplified or omitted. Those skilled in the art will appreciate variations from these embodiments that fall within the scope of the invention. Those skilled in the art will appreciate that the features described below can be combined in various ways to form multiple embodiments and variations of the invention. As a result, the invention is not limited to the specific embodiments described below, but only by the claims and their equivalents.

Embodiments of the present disclosure are directed to a tool for traffic operations engineers, and transportation planners to use to approximate or estimate the effects of construction or other impediments will have on sections of roadways. The tool may use traffic studies, GIS information, particular information about the construction project, and other information to create an approximation or estimation of the effects. The output information may include level of service (LOS), demand/capacity ratio, volume/capacity ratio, volume, flowrate, speed, and density in time-space format. The tool may use modelling and calibrating techniques to provide better estimations or approximations of the effects of the construction project will have on traffic.

FIG. 1 illustrates a sample method 100 for traffic evaluation and analysis. Method 100 receives information about a project 110, uses the input information to obtain related information 120, creates calibrated output information, 130, and displays the calibrated output information 140.

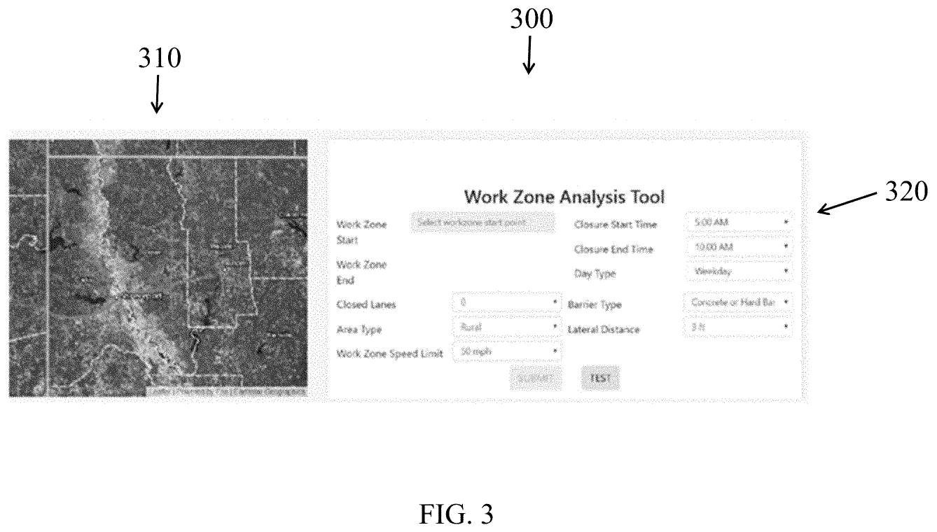

The received information 110 may include receiving information from a user via a user interface, such as depicted in FIG. 3. The information may relate generally to a construction project. The information may include the geographical work zone start, and work zone end point. This may be user selectable from a map 310. The information may also include number of lanes closed, area type, work zone speed limit, closure start time, closure end time, type of day, barrier type, and lateral distance. Other information may be used in addition to the listed information.

The input information may be used to obtain other information 120 about the project. The other information may include local conditions such as demand, urban or rural area, and terrain. The start and end point of the construction zone may be used to obtain specific other information. The other information may be obtained from a database, online resources, or other sources.

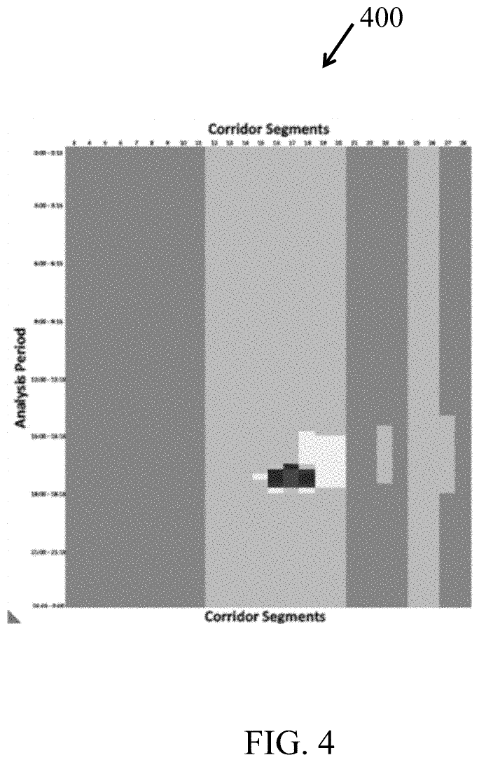

Output information may be created 130 based at least in part on the input information, other information, and calibration. The output information 130 may include parameters such as level of service (density-based), level of service (demand-based), speed, density, and volume. These parameters may be displayed as a space-time plot as shown in FIG. 4.

In some preferred embodiments, level of service (“LOS”) may include a unit-less quantitative stratification of a performance measure or measures representing quality of service. The measures used to determine level of service for transportation system elements are called service measures. There may be six levels of service, ranging from A to F. LOS A represents the best operating conditions from the traveler's perspective and LOS F the worst. LOS may be reported as density based when density is used as the service measure. LOS may be reported as demand based when demand is used as the service measure.

In some preferred embodiments, speed may include rate of motion expressed as distance per unit of time, generally as miles per hour. To characterize the speed of a traffic stream in these embodiments, a representative value must be used because a broad distribution of individual speeds is observable in the traffic stream. In these embodiments, several speed parameters can be applied to a traffic stream.

In some preferred embodiments, density may include number of vehicles occupying a given length of a lane or roadway at a particular instant. In these embodiments, density may be averaged over time and is usually expressed as vehicles per mile or passenger cars per mile. In these embodiments, a sample unit may be represented by vehicles per mile.

In these embodiments, volume may include the total number of vehicles passing over a given point or section of a lane or roadway during a given time interval. In these embodiments, any time interval can be used, but volumes are typically expressed in terms of annual, daily, hourly, or sub-hourly periods. In these embodiments, a sample unit may be represented by vehicles per day.

In these preferred embodiments, other parameters may include flow rate, delay, capacity, que length, demand over capacity ratio, and demand to capacity ratio. In these embodiments, calibration may include the process by which the analyst selects the model parameters that result in the best reproduction of field-measured local traffic conditions by the model.

In some preferred embodiments, displaying the output information 140 may include displaying the graph shown in FIG. 4, as well as the parameters and other parameters to indicate an estimated or modeled effect of the construction project on traffic and traffic flows.

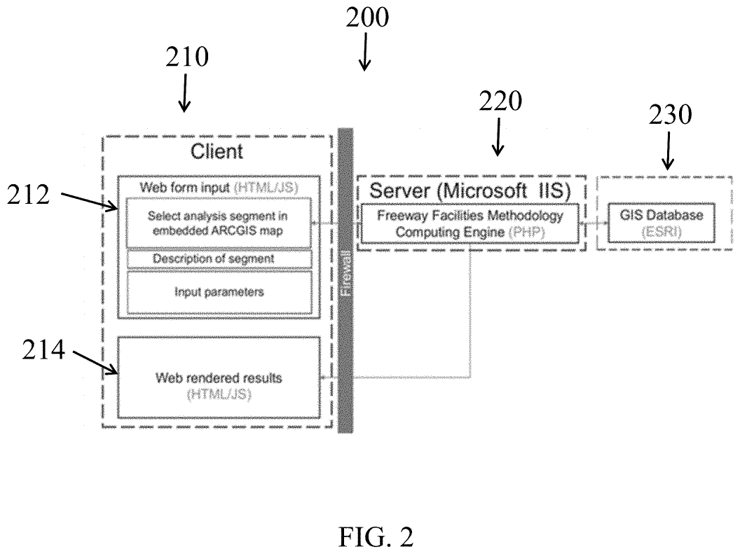

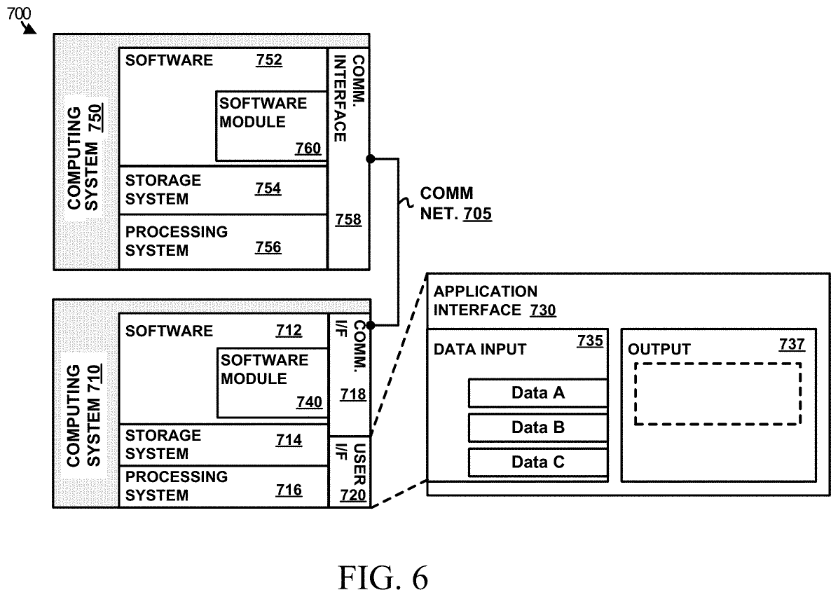

FIG. 2 illustrates a traffic reporting and analysis system environment 200, according to a preferred embodiment. In this embodiment, system 200 may include a client device 210. Client device 210 may generally correspond to computing system 710 in FIG. 6. In this embodiment, client device 210 may have the capability to display a user interface 212 and/or 300, and receive input information as outlined above. Client device 210 may also have the capability to display output information 214 and/or 400, including various parameters as outlined above.

In this embodiment, the input information may be received and used by server 220 to obtain other information, including information from GIS database 230. The input information may include the start point and end point of the project from the input information, which may define a segment. In this embodiment, there may be many different segments definable from the user interface via an interactive map (310 in FIG. 3). The segment data, along with other parameters may be used to obtain information from database 230, online information, and/or other information, and combinations thereof.

One advantage of the present system is that most, or all, needed information may be obtained in one database, thereby reducing time, errors, and complexity of the system. Another advantage may be that the system software resides on server 220, such that software upgrades may be completed more quickly and easily than if the software resided on the client device 210.

In these embodiments, server 220 may then create output information, which may then be displayed or presented 214 via client device 210. It will be appreciated that other device(s) and configurations may be used to implement the system and software.

FIG. 3 illustrates a user interface 300 showing the user input portions, according to a preferred embodiment. Interface 300 may include a map portion 310, and a fillable section 320. Map portion 310 may be used by a user to select start and end points of a construction project on the map. In this embodiment, these points may be used to define a segment. The segment may then be used to get GIS data about the specific segment. Accordingly, this may allow a user to select smaller segments than may be available from other tools. This may also provide better and more granular data about estimation of traffic conditions for a construction project.

In this embodiment, section 310 may allow a user to enter more parameters for the construction project. The parameters may include number of lanes closed, area type, work zone speed limit, closure start time, closure end time, type of day, and lateral distance. Other information may be entered and/or used in addition to the listed information.

FIG. 4 illustrates a user interface showing output 400, according to a preferred embodiment. In this embodiment, the output is a “heat map” of a certain parameter associated with each segment of a construction project. The vertical axis may be time, the horizontal access may be segments, and the various colors may indicate traffic density, speed, delay or other parameters. This may be useful to a user to visualize the effects or predicted effects of a construction project on traffic.

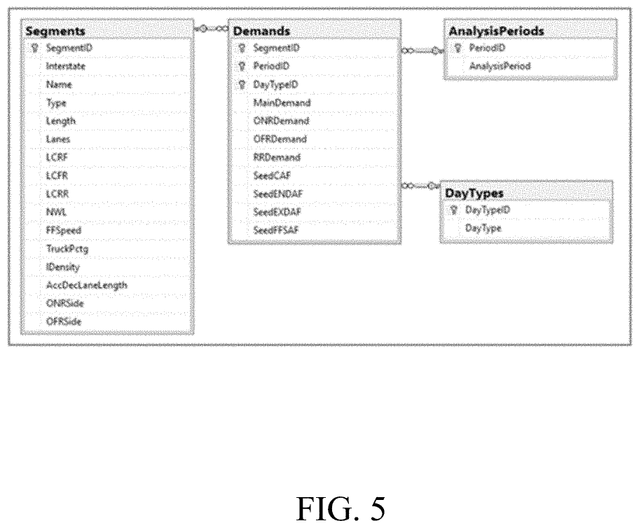

FIG. 5 shows the structure of a database 500, according to a preferred embodiment. In this embodiment, the database consists of four tables: Segments, Demands, Analysis Periods, and Day Types. The Segments table contains the attributes that are static during scenario evaluation. Most of the attributes are related to roadway geometry, although it also contains free-flow speeds and truck percentages. The Demands table contains attributes that are dynamic during scenario evaluation. Demand (veh/hr), as well as adjustment factors for different times of the day, are stored in this table. The Analysis Periods table contains a list of time periods, typically 15 minute bins, over which the analysis is conducted. In this embodiment, the Day Types table will provide flexibility for future versions of the tool.

FIG. 6 illustrates a traffic reporting and analysis system environment 700, according to a preferred embodiment. In this embodiment, computing environment 700 includes computing system 710 and computing system 750. In this embodiment, computing system 710 corresponds to client 210, and computing system 750 corresponds to server 220. In this embodiment, computing system 710 may include any smart phone, tablet computer, laptop computer, or other mobile device capable of receiving input data and displaying output data. In this embodiment, computing system 750 may include any server computer, desktop computer, laptop computer, or other device capable of storing and managing the data collected by computing system 710 or other similar computing systems.

In FIG. 6, computing system 710 includes processing system 716, storage system 714, software 712, communication interface 718, and user interface 720. In this preferred embodiment, processing system 716 loads and executes software 712 from storage system 714, including software module 740. When executed by computing system 710, software module 740 directs processing system 716 to receive input data, output data, and accomplish the steps and processes as outlined above. Such data could include any of the information described in the previous figures.

Although computing system 710 includes one software module in the present example, it should be understood that one or more modules could provide the same operation.

Additionally, computing system 710 includes communication interface 718 that can be configured to transmit data to computing system 750 using communication network 705. Communication network 705 could include the Internet or any other form of communication network.

Referring still to FIG. 6, processing system 716 can comprise a microprocessor and other circuitry that retrieves and executes software 712 from storage system 714. Processing system 716 can be implemented within a single processing device but can also be distributed across multiple processing devices or sub-systems that cooperate in executing program instructions. Examples of processing system 716 include general purpose central processing units, application specific processors, and logic devices, as well as any other type of processing device, combinations of processing devices, or variations thereof.

In this embodiment, storage system 714 can comprise any storage media readable by processing system 716, and capable of storing software 712. Storage system 714 can include volatile and nonvolatile, removable and non-removable media implemented in any method or technology for storage of information, such as computer readable instructions, data structures, program modules, or other data. Storage system 714 can be implemented as a single storage device but may also be implemented across multiple storage devices or sub-systems. Storage system 714 can comprise additional elements, such as a controller, capable of communicating with processing system 716.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

In this embodiment, user interface 720 can include a mouse, a keyboard, a touch input device for receiving a gesture from a user, and other comparable input devices and associated processing elements capable of receiving user input from a user. These input devices can be used for defining data about distribution units or equipment. Output devices such as a graphical display and a printer may also be included in user interface 720. The aforementioned user input and output devices are well known in the art and need not be discussed at length here.

In this embodiment, application interface 730 can include data input 735 and image capture 737. In one example, data input 735 can be used to collect user inputs, information, and parameters regarding a construction project. It should be understood that although computing system 710 is shown as one system, the system can comprise one or more systems to collect data.

In this embodiment, computing system 750 includes processing system 756, storage system 754, software 752, and communication interface 758. Processing system 756 loads and executes software 752 from storage system 754, including software module 760. When executed by computing system 750, software module 760 directs processing system 710 to store and manage the data from computing system 710 and other similar computing systems. In this embodiment, although computing system 710 includes one software module in the present example, it should be understood that one or more modules could provide the same operation.

In this preferred embodiment, computing system 750 may also include communication interface 758 that can be configured to receive the data from computing system 710 using communication network 705.

Referring still to FIG. 6, processing system 756 can comprise a microprocessor and other circuitry that retrieves and executes software 752 from storage system 754. Processing system 756 can be implemented within a single processing device but can also be distributed across multiple processing devices or sub-systems that cooperate in executing program instructions. Examples of processing system 756 include general purpose central processing units, application specific processors, and logic devices, as well as any other type of processing device, combinations of processing devices, or variations thereof.

In this embodiment, storage system 754 can comprise any storage media readable by processing system 756, and capable of storing software 752 and data from computing system 710. Data from computing system 710 may be stored in a word, excel, or any other form of digital file. Storage system 754 can include volatile and nonvolatile, removable and non-removable media implemented in any method or technology for storage of information, such as computer readable instructions, data structures, program modules, or other data. Storage system 754 can be implemented as a single storage device but may also be implemented across multiple storage devices or sub-systems. Storage system 754 can comprise additional elements, such as a controller, capable of communicating with processing system 756.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

In some preferred embodiments, computing system 750 may include a user interface. The user interface may include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in the user interface. The aforementioned user input and output devices are well known in the art and need not be discussed at length here. It should be understood that although computing system 750 is shown as one system, the system can comprise one or more systems to store and manage received data.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

What is claimed is:

1. A method for traffic evaluation and analysis, comprising:
receiving initial parameters related to a highway construction project;
obtaining additional information related to the highway construction project, based at least in part on the initial parameters;
creating output information based at least in part on the initial parameters and the additional information; and
presenting the output information.

2. The method of claim 1, wherein the initial parameters include a geographical start point and end point of the highway construction project, which define a segment.

3. The method of claim 2, wherein the geographical start and end point are user selectable from a map interface.

4. The method of claim 1, wherein the initial parameters comprise number of lanes closed.

5. The method of claim 1, wherein the initial parameters comprise area type.

6. The method of claim 1, wherein the initial parameters comprise work zone speed limit.

7. The method of claim 1, wherein the initial parameters comprise closure start time.

8. The method of claim 1, wherein the initial parameters comprise closure end time.

9. The method of claim 1, wherein the initial parameters comprise type of day.

10. The method of claim 1, wherein the initial parameters comprise lateral distance.

11. The method of claim 1, wherein the additional information is contained in a single database.

12. The method of claim 1, wherein the output information comprises level of service that is density-based.

13. The method of claim 1, wherein the output information comprises level of service that is demand-based.

14. The method of claim 1, wherein the output information comprises at least one of speed, density, volume, flow rate, delay, capacity, queue length, demand over capacity ratio or demand to capacity ratio.

15. A system for estimating the effects of a construction project on traffic, comprising a server configured to:
receive initial parameters related to a highway construction project;
obtain additional information related to the highway construction project, based at least in part on the initial parameters;
create output information based at least in part on the initial parameters, and/or the additional information; and
present the output information.

16. The system of claim 15, wherein the initial parameters include a geographical start point and end point of the highway construction project, which define a segment, and wherein the geographical start and end point are user selectable from a map interface.

17. The system of claim 15, wherein the initial parameters comprise at least of number of lanes closed, area type, work zone speed limit, closure start time, closure end time, type of day, lateral distance.

18. The system of claim 15, wherein the output information comprises at least one of level of service that is density-based, level of service that is demand-based, speed, density, volume, flow rate, delay, capacity, queue length, demand over capacity ratio or demand to capacity ratio.

19. The system of claim 15, wherein the additional information is contained in a single database.

20. A method for traffic evaluation and analysis, comprising:
receiving initial parameters related to a highway construction project;
obtaining additional information related to the highway construction project, based at least in part on the initial parameters;
creating output information based at least in part on the initial parameters and the additional information; and
presenting the output information, wherein the initial parameters include a geographical start point and end point of the highway construction project, which define a segment, wherein the geographical start and end point are user selectable from a map interface, and wherein the additional information is contained in a single database.
